(19) United States
(12) Patent Application Publication
(10) Pub. No.: US 2002/0066098 A1
(43) Pub. Date: May 30, 2002

(54) Digital broadcast receiver and program retrieval display method for the same and recording medium for recording control program for the same

(75) Inventor: Tomohisa Hamakawa, Tokyo (JP)

Correspondence Address: SUGHRUE, MION, ZINN,, MACPEAK & SEAS, PLLC, 2100 Pennsylvania Avenue, N.W., Washington, DC, 20037-3202, US

(73) Assignee: NEC CORPORATION

(21) Appl. No.: 09/985,866

(22) Filed: Nov. 6, 2001

(30) Foreign Application Priority Data
Nov. 8, 2000 (JP) 2000-339802

(51) Int. Cl. G06F 3/00; H04N 5/445; G06F 13/00

(52) U.S. Cl. 725/39

(57) ABSTRACT

A digital broadcast receiver is provided that can retrieve programs through simple manipulation. The data processor 16 implements program retrieval based on information input from the input device 17, the program information manager 18, the retrieval condition DB 20, the icon DB 21, the display condition storage 22, and the display condition storage 23. When new program information is received or updated, the program information manager 18 stores the new program information into the program information DB 19 or updates it. The retrieval condition DB stores plural groups, each being formed of an input program retrieval condition and a name, description, or the type of icon, added to the input program retrieval condition. The icon DB 21 stores an icon which can correspond to a program retrieval condition. The display information storage 22 holds information acquired through retrieval and information about display location or displaying/non-displaying. The display condition storage 23 stores information about actually-used condition specification and information about display content specification.

### BACKGROUND OF THE INVENTION

The present invention relates to a digital broadcast receiver and to a program retrieval displaying method used for the receiver and to a recording medium on which a control program for the receiver is recorded. Particularly, the present invention relates to a program retrieving method suitable for digital broadcasting reception.

In the digital broadcasting, the broadcasting service is broadly spreading in which an electronic program guide (EPG) containing program's names, genre, broadcasting hours, and the like, as added information concerning television programs are multiplexed with broadcasting waves so that the electronic program guide can be utilized through receivers. This electronic program guide allows users to quickly retrieve favorite programs from among a great amount of programs.

Reflecting small requests of users in program retrieval conditions requires inputting many items and leads to the troublesome inputting operation every retrieval and to an onerous operation. This may narrow the choice by users. In order to solve such a problem, the scheme has been proposed that registers program retrieval conditions and performs program retrieval through a preset button operation or through an automatic timer operation, thus selecting a desired channel.

When the above-mentioned scheme is used, it is considered that users may perform the retrieval with different intentions in various situations. Because users may access through television, plural retrieval conditions are required to be registrable. However, when a remote control, for example, may be used as an input device, it is physically difficult that preset buttons respectively corresponds to all registered retrieval conditions.

One preset button corresponding to plural retrieval conditions causes the problem that it is difficult to recognize that which one among plural programs a retrieval condition has matched as a result of retrieval operation unless the content of each program is ascertained through sequential channel selection.

Moreover, it may be considered that the program retrieval is automatically performed with suitable timing through a timer process, in accordance with a registered retrieval condition. However, the retrieval condition may hit plural programs or a program of less interest than the program during watching. Hence, it is not true that the direct channel select is always convenient. Moreover, the method of once displaying a retrieval result and then waiting an instruction from a user, for example, the method of simply displaying a program's title may disturb watching a current program. That is, it is often difficult to recognize the retrieval result unless the retrieval condition, including “what is a hit condition?” or “whose favorite program?”, is ascertained or unless a channel is once changed.

### SUMMARY OF THE INVENTION

The present invention is made to solve the above-mentioned problems.

An object of the present invention is to provide a digital broadcast receiver which is capable of retrieving a program through a simple procedure.

Another object of the present invention is to provide a program retrieval displaying method used for a digital broadcast receiver, which is capable of retrieving a program through a simple procedure.

Still another object of the present invention is to provide a recording medium on which a control program for the receiver is recorded, which is capable of retrieving a program through a simple procedure.

According to the present invention, a digital broadcast receiver receives a digital broadcast using program information distributed by an electronic program guide. The broadcast receiver comprises a display information storage for storing a retrieval condition for the program information, externally input, and display information corresponding to the retrieval condition; a program information storage for storing program information separated from the digital broadcast; a program retriever for comparing the program information retrieval condition with program information stored in the program information storage and extracting program information matching the retrieval condition; and a display for displaying a retrieval result. Thus, the program information retrieval result is displayed with display information corresponding to the program information retrieval condition.

Moreover, according to the present invention, a program retrieval display method is suitable for a digital broadcast receiver. The digital broadcast receiver is received using program information distributed by an electronic program guide. The program retrieval display method comprises the steps of comparing program information stored in a program information storage with a program information retrieval condition stored in a display information storage and then extracting program information matching the retrieval condition, the display information storage storing program information separated from the digital broadcast, the display information storage storing the program information retrieval condition externally input and display information corresponding to the program information retrieval condition; and displaying a retrieval result. Thus, the program information retrieval result is displayed in accordance with display information corresponding to the program information retrieval condition.

Moreover, the present invention is characterized by a recording medium on which a program retrieval display control program for a digital broadcast receiver is recorded. The digital broadcast receiver receives a digital broadcast using program information distributed by an electronic program guide. The program retrieval display control program comprises the steps of comparing program information stored in a program information storage with a program information retrieval condition stored in a display information storage, the program storage storing program information separated from the digital broadcast, the display information storage storing the program information retrieval condition externally input and the display information corresponding to the retrieval condition; extracting program information matching the condition; displaying a retrieval result; and displaying the program information retrieval result in accordance with display information corresponded to the program information retrieval condition.

That is, the digital broadcast receiver relates to a digital broadcast receiver in which program information distributed with an electronic program guide (EPG) can be used.

In the digital broadcast receiver, a program retrieval condition is previously registered in connection with information concerning a name or icon. A program is retrieved in accordance with the registered condition. A related name or icon is displayed when the result is registered. A user is informed of the beginning of a program to select a channel.

More specifically, in the digital broadcast receiver, when a user enters a program retrieval condition for program retrieval and the name, description, and icon corresponding thereon, using the input device, the data processor converts the input program retrieval condition in a suitable internal format. Then the data processor stores it into the retrieval condition database, together with the corresponding name and icon (registration of retrieval condition).

Moreover, in the digital broadcast receiver, upon the starting of a program retrieval, the data processor extracts the retrieval condition registered under the retrieval condition. Then, the program information manager executes program retrieval using the program information stored/managed in/by the program information database.

When finding the program matching the retrieval condition, the data processor stores the program information into the display information storage, in connection with the name, description and icon registered though the retrieval condition registration. After completion of the program retrieval, the data processor creates display information based on the information stored in the display information storage and then sends it to the synthesizer. After the display information is synthesized with a video image, the output device displays the result. While viewing the information about an icon, the user can select a channel through the manipulation of the input device or continuously watch the current program, with the display information erased.

This feature eliminates that the user inputs a retrieval condition every retrieval operation so that the program retrieval can be performed through simplified manipulation. Moreover, with the icon or name related to a retrieval condition at the time of displaying a retrieval result, a program by a user, “whose favorite program” or “the kind of a program” is captioned. Hence, the user can determine to continue watching or to select a retrieved program, even under such environments that plural users register plural retrieval conditions, without ascertaining a retrieval condition or changing a channel.

Therefore, that feature can eliminate the input operation necessary for program retrieval every time so that the system can be simply utilized. The receiver can have the program retrieval function of providing an easy display manipulation even in such an environment that plural users may register plural program retrievals, so that the program watching is seldom disturbed.

### BRIEF DESCRIPTION OF THE DRAWINGS

This and other objects, features and advantages of the present invention will become more apparent upon a reading of the following detailed description and drawings, in which;

FIG. 1 is a block diagram illustrating the configuration of a digital broadcast receiver according to the present invention;

FIG. 2 is a flowchart illustrating the registration process of a digital broadcast receiver according to the present invention;

FIG. 3 is a flowchart illustrating the retrieval process of a digital broadcast receiver according to the present invention;

FIG. 4 is a diagram illustrating a normal video display mode according to the present invention;

FIG. 5 is a diagram illustrating an example of a program matching a certain condition, displayed by retrieving under retrieval conditions registered through a user manipulation;

FIG. 6 is a diagram of an example of only the icon displayed as a retrieval result through a change in display condition according to the present invention;

FIG. 7 is a block diagram illustrating the configuration of a digital broadcast receiver according to another embodiment of the present invention; and

FIG. 8 is a flowchart showing a retrieval process of a digital broadcast receiver according to another embodiment of the present invention.

### DESCRIPTION OF THE EMBODIMENTS

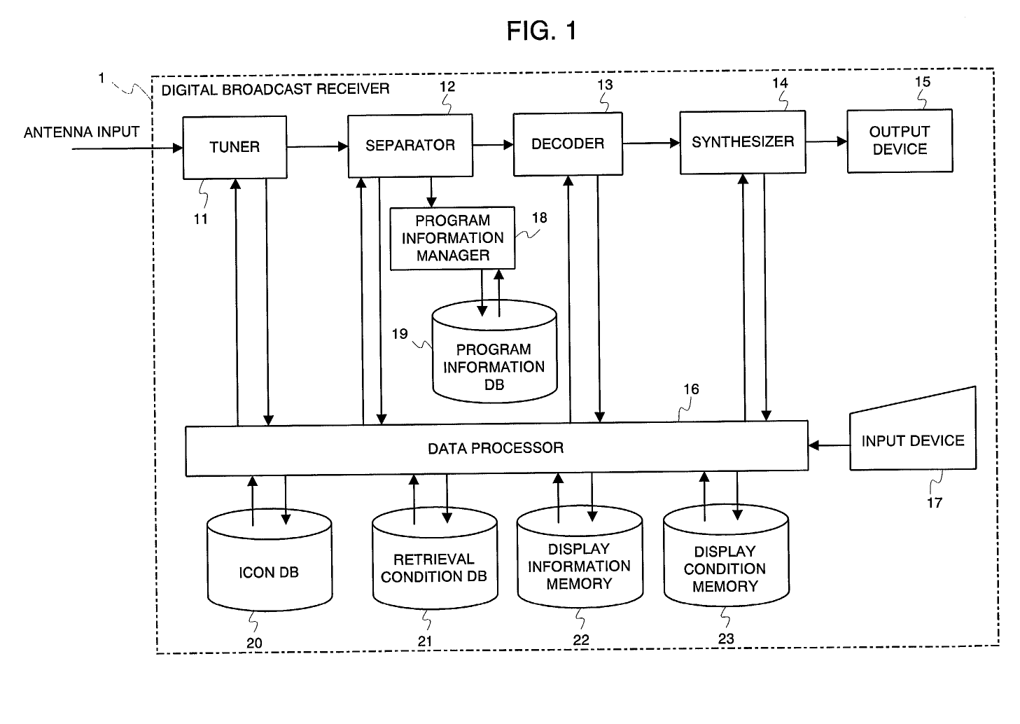

An embodiment of the present invention will be described below by referring to the attached drawings. FIG. 1 is a block diagram illustrating the configuration of a digital broadcast receiver according to the present invention. Referring to FIG. 1, the digital broadcast receiver 1 includes a tuner 11, a separator 12, a decoder 13, a synthesizer 14, an output device 15, a data processor 16, an input device 17, a program information manager 18, a program information database (DB) 19, a retrieval condition DB 20, an icon DB 21, a display information storage 22, and a display condition storage 23. The tuner 11 receives digital broadcasting radio waves and demodulates digital signals. The separator 12 separates and extracts video signals, audio, characters, subtitles, program information, and the like, from digital signals demodulated by the tuner 11 and then supplies each set of information to respective elements. The decoder 13 decodes videos, audio, characters and subtitles, and the like, supplied from the separator 12, in a predetermined display format.

The synthesizer 14 synthesizes video data decoded by the decoder 13 with program information, a retrieval condition registration form, a retrieval result, and others, supplied from the data processor 16, and then the synthesized data to the output device 15. The output device 15, which has, for example, a cathode ray tube or a loud speaker, displays the video information supplied from the synthesizer 14 and reproduces the audio information.

The data processor 16 controls the tuner 11, the separator 12, the decoder 13, and the synthesizer 14 to display the selected and received video, audio, character/subtitle, and various data, on the output device 15. The data processor 16 also implements a computational process concerning program retrieval based on the input device 17, the program information manager 18, the retrieval condition DB 20, the icon DB 21, the display information storage 22, and the display condition storage 23.

The data processor 16 includes a storage that stores a program for executing a predetermined computation process, in addition to an arithmetic and logic unit for computational process and a storage to be temporarily used. The input device 17 has means, such as a keyboard, a mouse, or a remote control, that receives various types of information necessary for program retrieval condition registration and that performs a retrieval operation

The program information processor 18 receives program information from the separator 12 and stores new program information to the program information DB 19 or updates the program information DB 19, in agreement with the new reception or updating of new program information. The program information DB 19 stores received program information.

The retrieval condition DB 20 can store plural groups each of a program retrieval condition input from the input device 17 and a name, description, the type of icon, or the like, added thereto, thus sequentially issuing them. The icon DB 21 stores an icon (image information) that can correspond to program retrieval condition.

The display information storage 22 holds information obtained as a result of retrieval and information concerning focus location, displaying/non-displaying, or the like. When detecting the manipulation of an icon displayed after retrieval, the data processor 16 performs a display changing operation such as focus movement or a station selecting process, using the information stored therein.

The display condition storage 23 stores information concerning specification of an actually-used condition or information concerning specification of the display content of an icon or name displayed at a retrieval result display time, among registered retrieval conditions. The data processor 16 deals with the above-mentioned information as a result of manipulation of the input device 17.

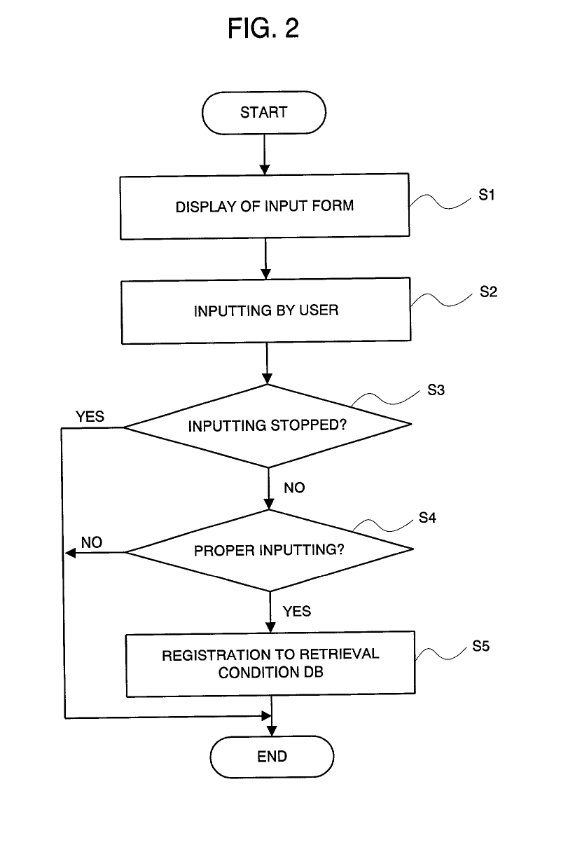

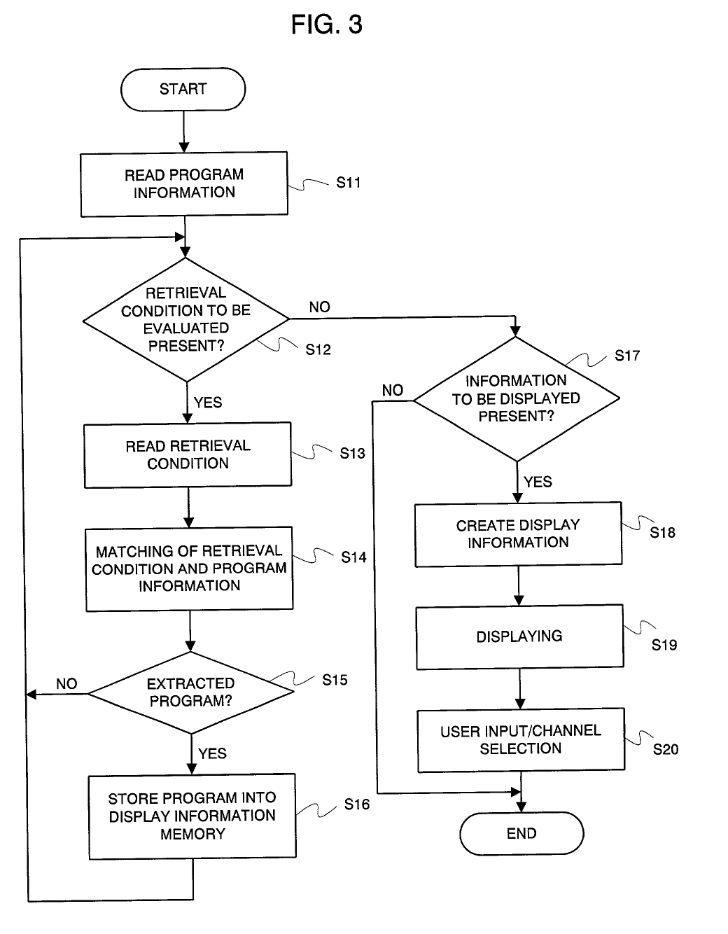

FIG. 2 is a flowchart illustrating a registration process of the digital broadcast receiver 1 according to the present invention. FIG. 3 is a flowchart illustrating the retrieval process of the digital broadcast receiver 1 according to the present invention. The operation of the digital broadcast receiver 1 according to the embodiment of the present invention will be described below by referring to FIGS. 1 to 3. Now, it is assumed that a program having various functions to be described later is loaded to the storage (not shown) (which may be a ROM (read-only memory) or an IC (integrated circuit) memory) within the data processor 16 and that the various functions are ready to be executable. Radio waves, received by an external device (not shown) such as an antenna, are demodulated into digital signals using the tuner 11. The separator 12 separates the digital signals into video data, audio data and program information. The program information manager 18 receives the program information and stores it into the program storage DB 19, thus managing it.

The decoder 13 decodes the video data and the audio data. Then, the synthesizer 14 performs necessary synthesis processes and issues the results in the form of video and audio, through the output device 15. A user registers a program retrieval condition in accordance with the procedure of FIG. 2, independently of the display of the video and the reproduction of audio and the storage of program information.

In the program retrieval condition registration, the input device 17 is manipulated to fist input a retrieval condition (step S1 in FIG. 2). When detecting the beginning of the condition inputting, the data processor 16 sends a retrieval condition input indication/form to the synthesizer 14 to display it on the output device 15 (step S2 in FIG. 2).

A user manipulates the input device 17 in accordance with the displayed input indication or form to input a retrieval condition, the name thereof, description, a corresponding icon, and the like. Here, the retrieval condition is defined as a combination of sets of character string information each such as a program type or a performer. The name or description is defined as character string information for purpose of displaying.

The icon corresponds to image information represented with, for example, a bitmap. The data processor 16 may list the information previously recorded in the icon DB 21 and select a specific one from the sets of information displayed on the output device 15 through the synthesizer 14. Since the output device 15 receives and displays the input content through the synthesizer 14, the system can be manipulated in an interactive mode (step S3 in FIG. 2).

The user can stop the registration process on the way through a predetermined input manipulation (step S4 in FIG. 2). If the registration process ends due to an event except the stop indication, the data processor 16 verifies whether or not the registered condition is appropriate (step S5 in FIG. 2). When the registered condition is appropriate, the data processor 16 registers the retrieval condition into the retrieval condition DB 20, thus completing the retrieval condition registration (steps S6 and S7 in FIG. 2).

In accordance with the procedure, shown in FIG. 3, the program retrieval is performed using the program retrieval condition registered in accordance with the procedure shown in FIG. 2.

First, when a user issues instructions using the input device 17, retrieval initiates. This is, for example, the operation of depressing a retrieval start button. Upon the retrieval initiation, the data processor 16 reads program information stored in the program information DB 19 through the program information manager 18 (step S11 in FIG. 3).

In succession, the data processor 16 checks whether or not there are retrieval conditions stored in the retrieval condition DB 20. If yes, the data processor 16 reads the retrieval condition. When plural retrieval conditions are registered, the data processor 16 extracts them one by one (steps S12 and 13 in FIG. 3).

The data processor 16 subjects the read program information and the retrieval condition to a matching process and extracts the information matching the condition, thus storing it into the display information storage 22. At that time, the data processor 16 reads the information about the retrieval condition to be used from the display condition storage 23 and thus uses it in the matching process (steps S14 to S16 in FIG. 3).

The data processor 16 repeatedly executes the process ranging the step S12 to the step S16 under all the retrieval conditions registered in the display condition storage 23. When evaluating all the retrieval conditions, the data processor 16 reads icons and names from the retrieval condition DB 20, based on the information stored in the display information storage 22, and thus creates the display information. At that time, the data processor 16 reads conditions concerning display contents out of the display condition storage 23 and creates the display information in accordance with the conditions concerning, for example, only the icon or icon and name (steps S17 and S19 in FIG. 3).

The data processor 16 sends the created display information to the synthesizer 14 and synthesizes it with video data. Then, the output device 15 displays the synthesized data (step S19 in FIG. 3). When the user handles the displayed icon with the input device 17, the data processor 16 detects it and reads the related information stored in the display information storage 22. Thus, the data processor 16 subjects the tuner 11 to channel selection control to perform the channel switching (step S20 in FIG. 3).

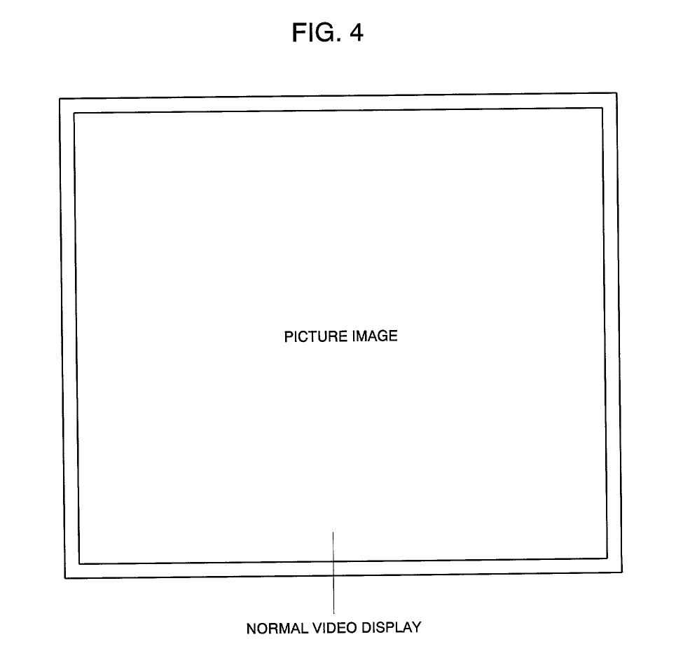

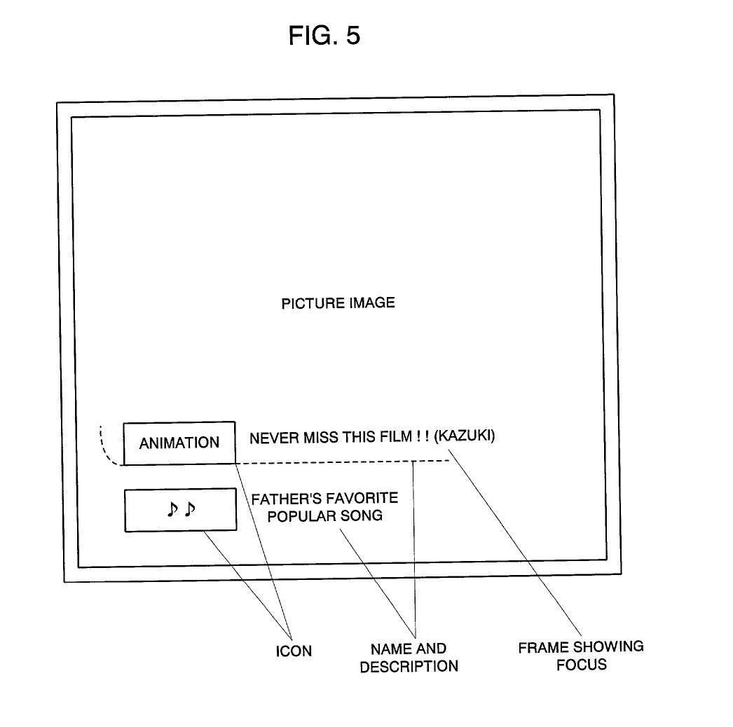

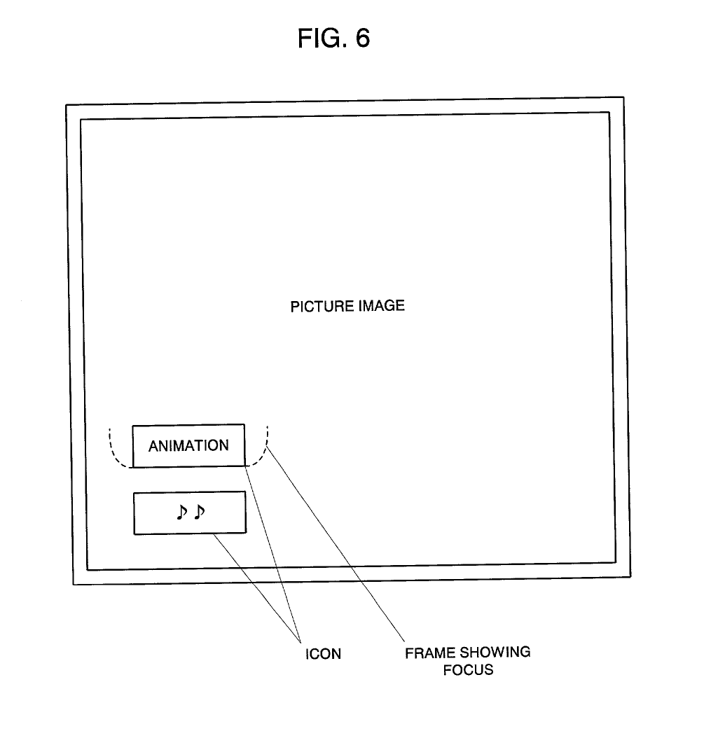

FIG. 4 is a diagram illustrating a normal video display according to an embodiment of the present invention. FIG. 5 is a diagram illustrating the example where retrieval is performed under the retrieval condition registered by user's manipulation and a program matching a certain condition is displayed, according to an embodiment of the present invention. FIG. 6 is a diagram illustrating the example where only the icon is displayed as a retrieval result due to a change in display condition, according to an embodiment of the present invention. The example of changing the screen display, according to the embodiment of the present invention, will be described below by referring to FIGS. 4 to 6. Here, it is assumed that plural retrieval conditions are previously registered and the retrieval is evaluated.

With the normal video display shown in FIG. 4, when retrieval is executed under retrieval conditions registered by user's manipulation, the program matching a certain condition shown in FIG. 5 is displayed. With the channel selection through icon selection or the off operation of a retrieval result display, the retrieval result is erased from the screen. Then, only the video shown in FIG. 4 is again displayed. When the display condition is changed, only the icons shown in FIG. 6 are displayed as retrieval results.

As shown in FIGS. 5 and 6, when the display information corresponds to an icon, name, or description registered by a user, the user wanting a notified program can recognize the importance thereof at a glance. Hence, the user can intentionally decide to change the channel after completion of a current program or to continue watching the current program, without changing the channel or ascertaining conditions.

As described above, registering retrieval conditions in advance can eliminate inputting conditions every program retrieval time. Moreover, even when plural users register plural conditions, the user can recognize at a glance the program matching a retrieval condition because the retrieval result display corresponds to a name or icon at a registration time. This allows a desired program to be selected and watched, with no troublesome manipulation. That is, the program retrieval can be accomplished through the simple manipulation.

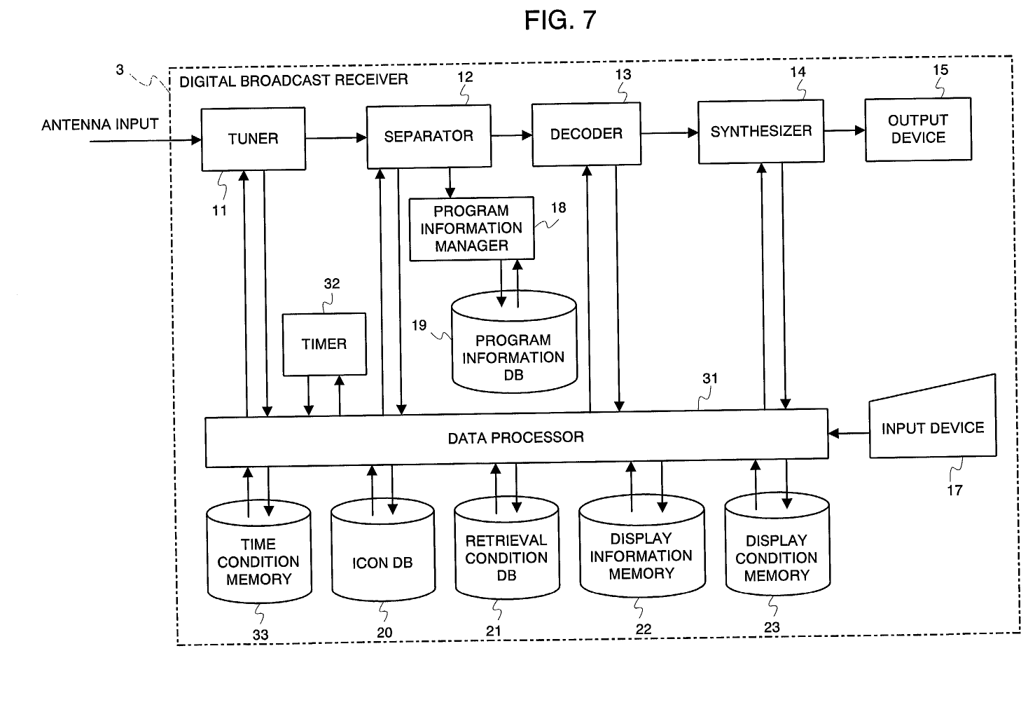

FIG. 7 is a block diagram illustrating the configuration of a digital broadcast receiver according to another embodiment of the present invention. Referring to FIG. 7, the digital broadcast receiver 3 differs from the digital broadcast receiver 1 shown in FIG. 1, in that both a timer 32 and a time condition storage 33 are disposed. Like numerals are attached to the same constituent elements as those in the first embodiment. The operation of each of the same constituent elements is the same as that in the first embodiment.

The timer 32, which has the function of a calendar and timepiece, can tell a current date or time to the data processor 31. The timer 32 also has the function of telling a predetermined date or time to the data processor 31.

The time condition storage 33 stores time conditions used in retrieval. Here, the time condition is relates to a program broadcasting hour including “from what time to what time”, “now only on the air”, or “to be started within five minutes”. The user can input the time condition by manipulating the input device 17.

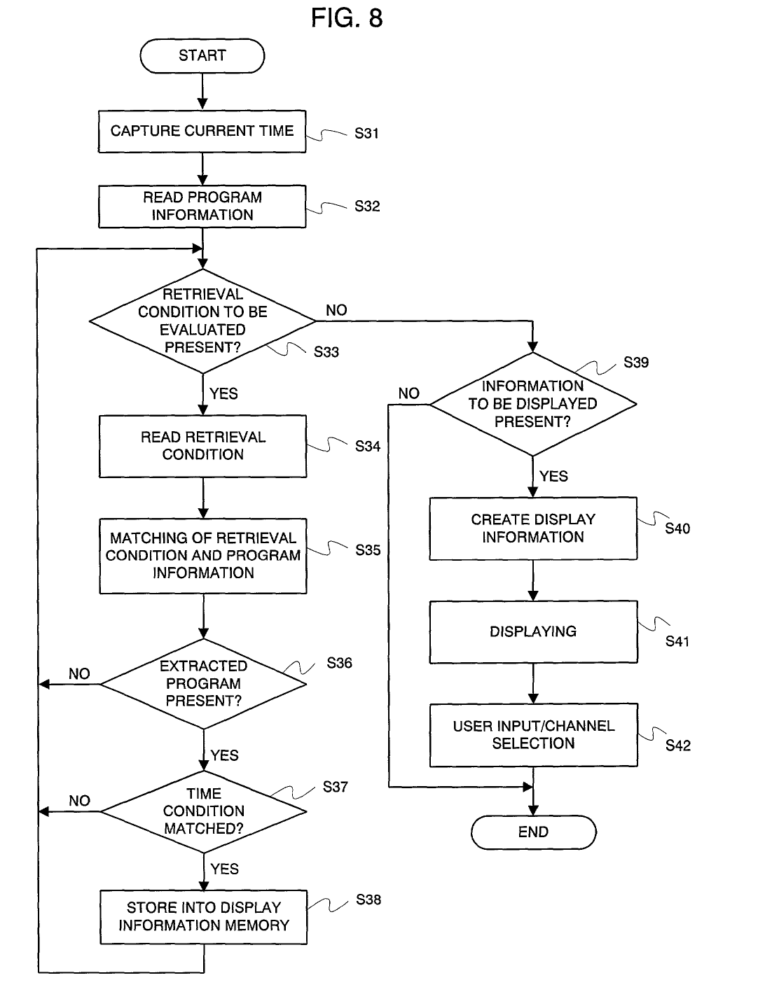

FIG. 8 is a flowchart showing the retrieval process of the digital broadcast receiver 3 according to another embodiment of the present invention. The operation of the digital broadcast receiver 3 will be described below by referring to FIGS. 7 and 8.

The retrieval starts through the triggering of the timer 32. This operation starts with the occurrence of periodic triggers or with the occurrence of a trigger at the time specified by the input device 17. The data processor 31 reads a current time issued from the timer 32 (step S31 in FIG. 8).

In succession, the data processor 31 reads the program information stored in the program information DB 19 through the program information manager 18 (step S32 in FIG. 8). The data processor 31 checks whether or not there are retrieval conditions registered in the retrieval condition DB 20. If yes, the data processor 31 reads a corresponding retrieval condition. When the retrieval condition DB 20 holds plural retrieval conditions, the data processor 31 sequentially reads them out one by one (steps S33 and S34 in FIG. 8).

The data processor 31 subjects the read program information and the retrieval condition to a matching process and then extracts the program information matching the retrieval condition. In this case, the data processor 31 reads information on the retrieval condition to be used from the display condition storage 23 and uses it for the matching process (steps S35 and S36 in FIG. 8).

Moreover, the data processor 31 narrows down the display information, in accordance with time information, such as a starting time, contained in the extracted program information, a read current time, and a time condition read from the time information storage 33. Thus, the data processor 31 stores the display information satisfying a retrieval condition into the display information storage 22 (steps S37 and 38 in FIG. 8). The data processor 31 repeatedly executes the process covering the steps S33 to S38 under all the registered retrieval conditions.

When evaluating all the retrieval conditions, the data processor 31 reads icons and names from the retrieval condition DB 20, based on the information stored in the display information storage 22, thus creating the information to be displayed. At this time, the data processor 31 reads the condition concerning the display content from the display condition storage 23 and creates the display information in accordance with conditions related to, for example, only the icon, or icon and name (steps S39 and 40 in FIG. 8).

The data processor 31 sends the created display information to the synthesizer 14 and synthesizes it with video data. Then the output device 15 displays the synthesized information (step S41 in FIG. 8). When the user manipulates a displayed icon by means of the input device 17, the data processor 31 detects the manipulated icon and reads the related information stored in the display information storage 22. Thus, the tuner 11 is controlled for channel selection to execute the channel switching operation (step S42 in FIG. 8).

In such an operation, the retrieval can be automatically initiated in response to triggers periodically or specifically issued from the timer 32. Moreover, the retrieval condition can be narrowed down using the date and time supplied from the timer 32 and the program starting time contained in the program information.

As described above, the present invention relates to the digital broadcast receiver that receives a digital broadcast with program information distributed with an electronic program guide. The program information stored in the program information storage which stores program information separated from a digital broadcast is compared with a program information retrieval condition stored in the display information storage. The display storage stores both a program information retrieval condition externally input and the display information corresponding to the retrieval condition. The program information matching the retrieval condition is extracted. Thus, in the retrieval result display, the program information retrieval result is displayed with the display information corresponding to the program information retrieval condition. Hence, this feature allows program to be advantageously retrieved through the simple manipulation.

The entire disclosure of Japanese Patent Application No. 2000-339802 filed on Nov. 8, 2000 including specification, claims, drawings and summary are incorporated herein by reference in its entirely.

What is claimed is:

1 A digital broadcast receiver, wherein a digital broadcast is received using program information distributed by an electronic program guide, comprises:
a display information storage for storing a retrieval condition for said program information, externally input, and display information corresponding to said retrieval condition;
a program information storage for storing program information separated from said digital broadcast;
a program retriever for comparing said program information retrieval condition with program information stored in said program information storage and extracting program information matching said retrieval condition; and
a display for displaying a retrieval result;
wherein said program information retrieval result is displayed with display information corresponding to said program information retrieval condition.

2 The receiver defined in claim 1, further comprising a graphic information storage for storing displayable graphic information, said graphic information stored in said graphic information storage corresponding to said retrieval condition as said display information.

3 The receiver defined in claim 1, wherein said display information comprises character information containing at least a name and description.

4 The receiver defined in any one of claims 1, further comprising:
a timer for informing a present date or time; and
a time condition storage for storing a time condition used to retrieve said program information;
wherein said program information is retrieved in accordance with a present date or time from said timer and in accordance with a time condition stored in said time condition storage.

5 A program retrieval display method suitable for a digital broadcast receiver, wherein said digital broadcast is received using program information distributed by an electronic program guide, comprising the steps of:
comparing program information stored in a program information storage with a program information retrieval condition stored in a display information storage and then extracting program information matching said retrieval condition, said display information storage storing program information separated from said digital broadcast, said display information storage storing said program information retrieval condition externally input and display information corresponding to said program information retrieval condition; and
displaying a retrieval result;
wherein said program information retrieval result is displayed in accordance with display information corresponding to said program information retrieval condition.

6 The program retrieval display method defined claim 5, wherein said display information comprises character information containing at least a name and description.

7 The program retrieval display method defined in claim 5, further comprising the step of checking graphic information as said display information against said retrieval condition, said graphic information being stored in said graphic information storage storing said displayable graphic information.

8 The program retrieval display method defined in any one of claims 5, further comprising the step of retrieving said program information in accordance with a present date or time from a timer and in accordance with a time condition stored in a time condition storage, said timer informing said current date or time, said time condition storage storing said time condition used to retrieve said program information.

9 A recording medium on which a program retrieval display control program for a digital broadcast receiver is recorded, said digital broadcast receiver receiving a digital broadcast using program information distributed by an electronic program guide, said program retrieval display control program comprising the steps of:
comparing program information stored in a program information storage with a program information retrieval condition stored in a display information storage, said program storage storing program information separated from said digital broadcast, said display information storage storing said program information retrieval condition externally input and said display information corresponding to said retrieval condition;
extracting program information matching said condition;
displaying a retrieval result; and
displaying said program information retrieval result in accordance with display information corresponded to said program information retrieval condition.
